(19) United States
(12) Patent Application Publication
(10) Pub. No.: US 2010/0279265 A1
(43) Pub. Date: Nov. 4, 2010

(54) Computer Method and System for Increasing the Quality of Student Learning

(75) Inventor: Neil T. Heffernan, Worcester, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: WORCESTER POLYTECHNIC INSTITUTE, Worcester, MA (US)

(21) Appl. No.: 12/738,060

(22) PCT Filed: Oct. 30, 2008
(86) PCT No.: PCT/US08/12336

§ 371 Date: Jul. 12, 2010

Related U.S. Application Data
(60) Provisional application No. 61/001,136, filed on Oct. 31, 2007.

(51) Int. Cl. G09B 7/00

(52) U.S. Cl. 434/350

(57) ABSTRACT

Today, students are underperforming on the standardized testing. In an effort to better performance on these tests, software systems allow a student to practice different topics. These software systems, however, do not perform a longitudinal analysis of a student allowing the creation of an adaptable learning environment for the system. In contrast, the present invention provides a system that enables a student to answer one or more questions of a problem set. Next, the system stores information for each answer of the one or more questions over a period of time, analyzes the information for each student answer in a longitudinal manner, and identifies one or more deficiencies in learning of the student based on the longitudinal analysis. In this way, the system uses longitudinal analysis to identify student deficiencies, which allows a teacher or parent, using the analysis, to increase the quality of learning for the student.

### RELATED APPLICATION

This application claims the benefit of U.S. Provisional Application No. 61/001,136, filed on Oct. 31, 2007. The entire teachings of the above application are incorporated herein by reference.

The entire teachings of U.S. Provisional Application Nos. 60/937,953 filed on Jun. 29, 2007 (now PCT/US2008/004061); 60/908,579, filed on Mar. 28, 2007 (now PCT/US2008/004061) and International Patent Application No. PCT/US2006/027211 filed on Jul. 13, 2006 are incorporated herein by reference.

### GOVERNMENT SUPPORT

The invention was supported, in whole or in part, by a grant N00014-0301-0221, R305K030140, REC0448 from ONR, U.S. Dept. of Education, NSF; grant R305A070440 from U.S. Dept. of Education; and grant DRL0733286 from NSF Science Assistment. The Government has certain rights in the invention.

### BACKGROUND OF THE INVENTION

Across the nation, students are underperforming on the standardized tests mandated by the No Child Left Behind Act (NCLB) (Olson, 2005; Swanson, 2006). For example, over 60% of 8^{th}-grade students in Massachusetts failed to achieve a proficient level of performance in math in 2005-2006 (Massachusetts Department of Education www.doe.mass.edu). The problem is even noticeable for children that are minorities or from low-income families. In the industrial city of Worcester, Mass., for example, only 18% of students reached proficiency. The Worcester Public School (WPS) system is representative of many districts across the country struggling to address these problems. WPS seeks to use the Massachusetts Comprehensive Assessment System (MCAS) assessments in a data-driven manner to provide regular and ongoing feedback to students and teachers. The MCAS results, however, only arrive during the following academic year, too late to be useful for a teacher's students.

As a result, existing software systems in the commercial market have two types of assessments: 1) benchmark assessments (i.e. formative assessment) that are typically focused on a month or two of content and relate to a teacher's immediate instructional needs; and 2) summative assessments that allow principals and superintendents to track performance over time, but the assessments relate to one whole-year of content, which is less useful diagnostically. Examples of benchmark assessments include many locally developed tests, such as the public schools paper tests or a computerize summative assessment. Teachers, for example, grade the tests and report the students' final scores to the central office. Although these tests allow the teachers to see what items the students got wrong, there is no computer support in analyzing the test. Computerized summative assessments include similar limitations in that the system is not adaptive to a student's learning style.

### SUMMARY OF THE INVENTION

Embodiments of the present invention include computer implemented methods or corresponding systems for increasing the quality of learning for a student. In use, the invention system enables a student to answer one or more questions of a problem set. For each student, the system stores in a computer store information for each answer of the one or more questions over a period of time (e.g., summative). Using a digital processor, the system analyzes the stored information for each student answer in a longitudinal manner, tracks individual skills and identifies one or more deficiencies in learning of the student based on the longitudinal analysis. In this way, the system uses longitudinal analysis to identify student deficiencies, which in turn are used for increasing the quality of learning.

In one embodiment, the problem set is directed to one subject area, such as mathematics, science, English, history, foreign languages, etc. In another embodiment, the information that the system stores indicates a student result for each question and any predictive information about the student interaction. In another embodiment, the predictive information includes elapsed time per question, number of attempts, tutoring used, percentage correct, and other useful information about the student's interaction. In yet another embodiment, the invention system identifies the student's attitude in relation to the one or more deficiencies.

In still yet another embodiment, a computer system analyzes the information for each student answer in a longitudinal manner, which is summative of a student's learning over the period of time, wherein summative includes an accumulation of skills. Further, embodiments also generate a report for the student based on the longitudinal analysis. In an example embodiment, the system generates a report for a student that is viewed and a user, based on the report, adapts a learning program for the student. In some embodiments, the user is a parent or teacher. In an alternative embodiment, a teacher adapts a classroom teaching program based on the longitudinal analysis of one or more students.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows a web-based assessment system entry screen for accessing a tutoring software having questions for students in accordance with embodiments of the present invention;

FIG. 2 provides a screenshot displaying a math problem/question to a student using the ASSISTment tutoring system according to embodiments of the present invention;

FIG. 3A shows an example embodiment displaying a web-based report having results and a knowledge component (skill) for each student according to an example embodiment of the present invention;

FIG. 3B shows an example embodiment displaying a web-based report allowing a teacher to identify the skills for each student in accordance with embodiments of the present invention;

FIG. 4 shows multiple screen shots a user can customize in accordance with embodiments of the present invention;

FIG. 5A shows a report display for a teacher providing student skills for a topic in accordance with embodiments of the present invention;

FIG. 5B depicts a class summary for review by a teacher in accordance with embodiments of the present invention;

FIG. 6 shows an interface for setting different time allocation percentages for assessments problems in accordance with embodiments of the present invention;

FIGS. 7A-7B shows a report providing detailed information of a student's performance for review by parents, teachers, and/or students in accordance with embodiments of the present invention;

FIG. 8 shows a preference screen a parent may use for configuring how to receive a report in accordance with embodiments of the present invention;

FIGS. 9A-9B shows a tutoring display presented to a student in accordance with embodiments of the present invention; and

FIGS. 10A-10B provides an example problem presented for student completion in accordance with embodiments of the present invention.

FIGS. 11A-11C are schematic and block diagrams of a computer network and network architecture in which embodiments of the present invention operate.

### DETAILED DESCRIPTION OF THE INVENTION

A description of example embodiments of the invention follows. The teachings of all patents, published applications and references cited herein are incorporated by reference in their entirety.

### Student Assessment

Some systems provide a summative assessment for students. The summative assessments typically use a software program for testing students multiple times over a period of time (e.g., two years). In use, the software program samples a student's knowledge of a topic (e.g., mathematics, science, history, English, foreign languages, etc.) for each test. Each test, for example, samples randomly from a bank of thousands questions that are presented to the student. These questions are more summative in nature, and thus are useful for communicating growth over time. The summative assessments, however, sample a whole year's content and cannot track individual knowledge components (skills) effectively.

Both commercially available benchmark assessments and summative assessments generally provide reports to teachers that break down students' performance into 5-7 categories. Since benchmark assessments are focused on a small portion of the curriculum, their reports can be more diagnostically useful. If a summative assessment of a teacher's student in mathematics indicates the student is weak at “Number Sense” it is difficult for a teacher to determine what topic best aides a student's weakness. But if a benchmark assessment provides the teacher with an indication that the student is weak at “absolute values”, then the teacher can make an immediate data-driven decision about what topic would facilitate improving a student's weakness. It should be understood that these techniques may be applied to multiple students as part of a single summative assessment.

Given the different uses of benchmark and summative assessments, there is currently no solution that integrates both types of assessment. This is due mostly to the fact that there is difficult statistical problems to be solved before this is possible (Standard psychometric theory requires a fixed target for measurement (e.g. van der Linden and Hambleton, 1997), which requires that learning during testing be limited. Embodiments of the present invention solve this and other limitations. In particular, embodiments of the present invention are diagnostically useful and allow longitudinal tracking for students to facilitate better ways of capturing student growth in a longitudinal assessment.

### Longitudinal Assessment

Longitudinal assessment for a student provides a more effective way for student learning by understanding student behavior and learning style. Embodiments of the present invention employing longitudinal assessments implement at least one of the following: 1) frequent collection of data throughout a time period (e.g., a year) for longitudinally tracking progress as opposed to a single snapshot of a student; 2) providing more detailed data for each subject to teachers as opposed to reporting a few subjects to teachers; 3) including teachers in the benchmark assessments creation process; or 4) reporting/sharing the data with parents and/or teachers on a on-going/continuing basis.

Even in the presence of the best cognitive diagnostics, teachers can adapt to whole-class trends but have limited time to adapt to the idiosyncratic needs of each student. One such solution is to have parents assist with helping a student learn, but providing solutions to a specific child/student's needs is difficult. Even assuming the problem of individualized tutoring can be practically solved, the time for instruction should be minimized or risk consumption of valuable time for the next lesson. Consuming the time for the next lesson results in one or more students falling further behind.

As a particular approach to intelligent tutoring systems, Cognitive Tutors combines cognitive science theory, Human-Computer Interaction (HCI) methods, and particular Artificial Intelligence (AI) algorithms for modeling student thinking. Classroom evaluations of applicant's Cognitive Tutor Algebra course have demonstrated that students in tutor classes outperform students in control classes by 50-100% on targeted real-world problem solving skills and by 10-25% on standardized tests (Koedinger et al., 1997; Koedinger, Corbett, Ritter, & Shapiro, 2000; Morgan, P., & Ritter, S, 2002).

An ASSISTment system employing principals of the present invention solve these problems and facilitates better quality learning for one or more students. The ASSISTment system is described below in greater detail.

### ASSISTment System

An ASSISTment system allows a student to obtain a better quality of learning by using at least one of the following: 1) collecting data, frequently, throughout a time period (e.g., a year) for longitudinally tracking progress; 2) providing more detailed about the results and behavior of each subject to teachers; 3) including teachers in the assessments creation process; and/or 4) reporting/sharing the data with parents and/or teachers on a on-going/continuing basis. A more detailed explanation of the ASSISTment system is described below.

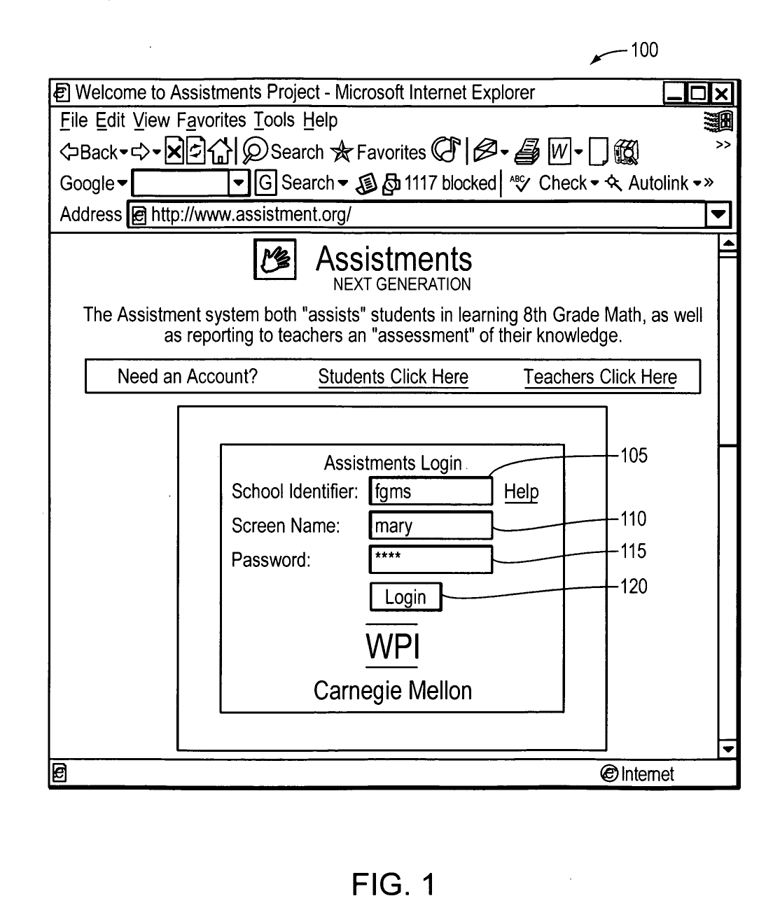

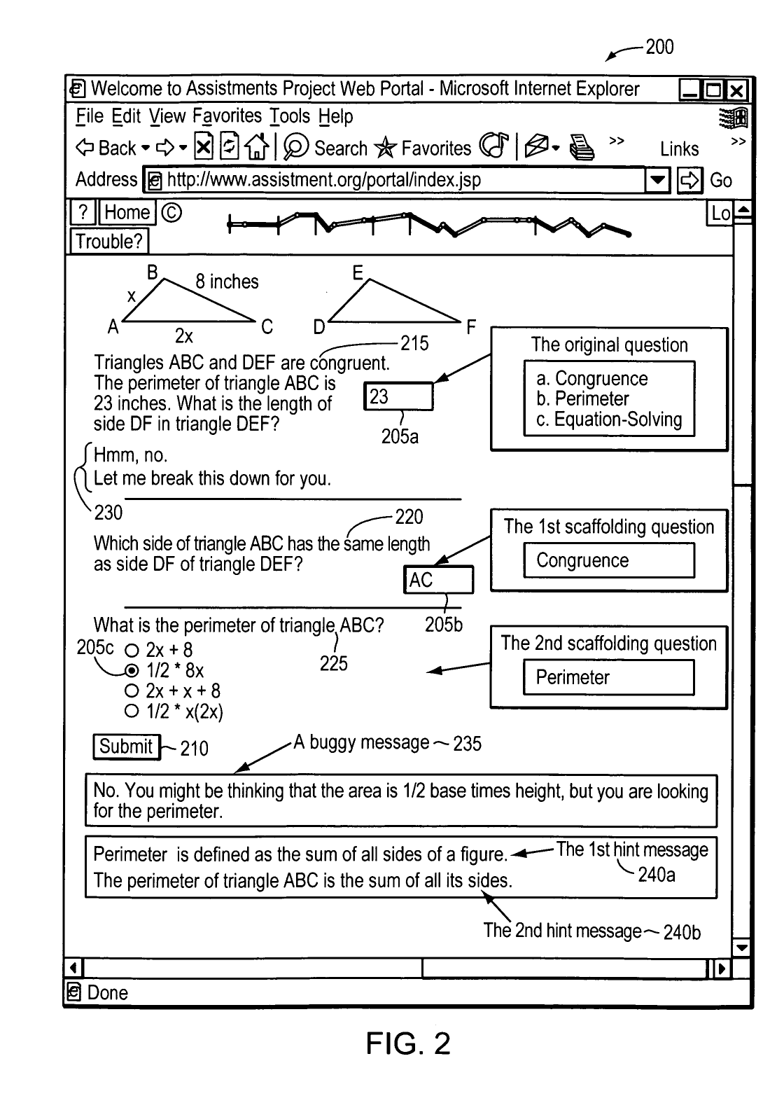

FIG. 1 shows a web-based assessment system entry screen 100 for accessing a tutoring software having questions for students. In particular, a student views the entry screen 100 and enters a school identifier 105, screen name 110, password 115, and presses the login button 120. After pressing the login button 120, the student begins the tutoring software, which typically presents a student with questions, such as a math problem. An example of a math problem presentation is seen in FIG. 2.

FIG. 2 provides a screenshot 200 displaying a math problem/question to a student using the ASSISTment tutoring system. In the screenshot 200, the ASSISTment tutoring system presents a math problem, such as a problem from a standardized test (e.g., Massachusetts Comprehensive Assessment System test). The math problem provides the student with a question 215 which challenges the student's understanding of algebra, perimeter, and congruence.

In use, the student answers the question 215 by inserting or selecting answers 205a,b,c and pressing a submit button 210. If the student answers the question 215 correctly, the student moves on to the next question/problem (e.g., another screen). On the other hand, if the student answers the question 215 incorrectly, the system presents the student with an appropriate response 230, such as “Hmm, no. Let me break this down for you.” As a result of the student's incorrect response, the system starts a tutor program and presents the student with additional follow-up questions (220, 225) for increasing a student's understanding of the topic. That is, the system provides a student with questions in such a manner as to isolate which student skills are deficient.

An example of a tutoring system determining student deficiencies is as follows. A tutor system begins by asking a first follow-up question 220 that relates to the congruence concept, which is a concept in original question 215. If the student does not provide the correct answer, the system provides additional tutoring. On the other hand, if the student answers the first follow-up question 220 correctly, the system provides the student with a second follow up question 225 to assess a new concept relating to original question 215, such as the perimeter concept. The system assesses whether the student has difficultly with the second follow up question 225. If so, the system presents a message 235 alerting the student of confusion between perimeter and area. As a result, the student may request one or more hints, such as hint messages 240a,b to assist in understanding of the concept.

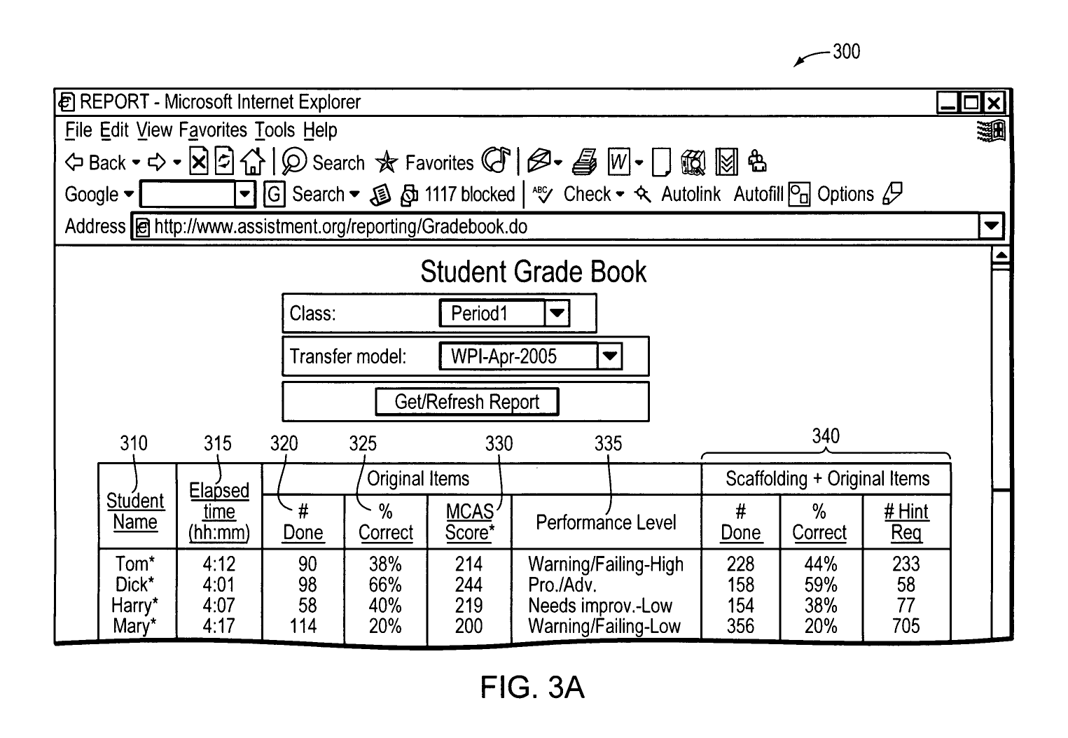

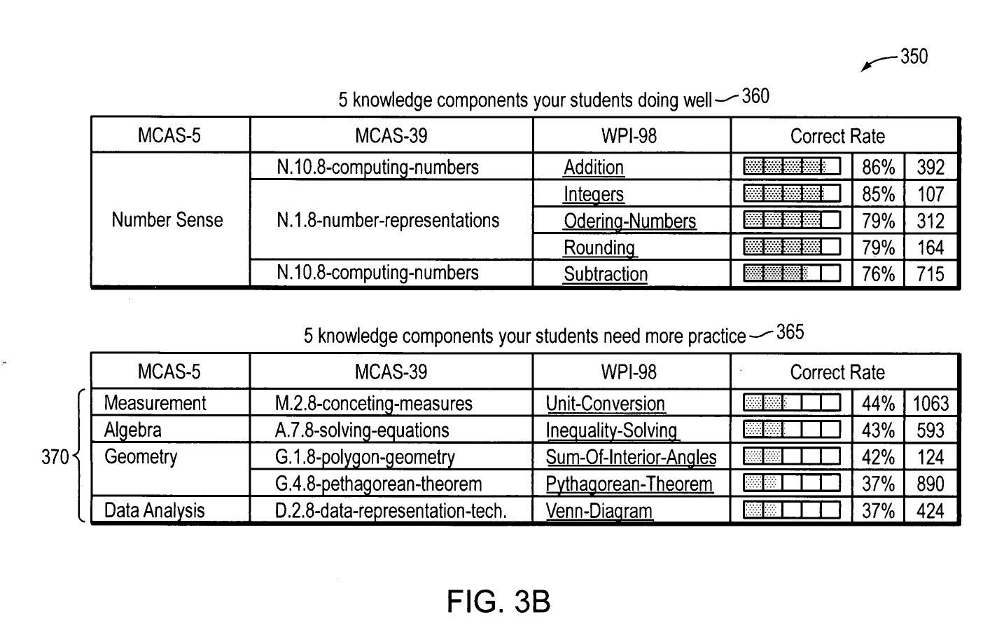

After reviewing the hint messages 240a,b, the student should be able to answer the second follow up question 225 correctly. If not, the system presents additional tutoring information. Once the student provides the correct answer, the tutoring system ends by asking original question 215 again. If the student does not answer the question 215 correctly, the tutoring system begins anew. If the student does answer the question 215 correctly, the student can transition to another problem/question, where the tutoring system continues for each incorrect answer/response. In this way, a student increase understanding of concepts for a subject area where the student has deficiencies. A system such as that of FIG. 2 is useful to students, but also useful to teachers who can obtain feedback, sometimes instantaneous/dynamically, on each student as seen in FIGS. 3A and 3B.

### Instructor Reports for ASSISTment System

FIG. 3A shows an example embodiment displaying a web-based report 300 having results and a knowledge component for each student. A skill is formed of one or more knowledge components. A teacher can use the web-based report to learn more about each student. For example, FIG. 3A shows student data 310 for Tom, Dick, Harry, and Mary. In this example, Tom's elapsed time 315 for using the ASSISTment system this year is 4 hours and 12 minutes, and Tom's number of completed problems 320 is 90. Further, Tom's percentage of correct problems 320 is 38%. The percentage of correct problems 320 is used to predict a standardized test score 330, such as a MCAS score of 214. The performance level 335 for this score is Warning/Failing-high. A teacher can use this information to quickly identify any students that are in need of additional help. It is useful to note, Tom's score of 214 is in the top half of the 200-220 range, so for Massachusetts calculation of AYP, he is worth 25 points on the MCAS Proficiency Index. By averaging each of the students' Proficiency index, one can obtain a Cumulative Proficiency Index (CPI), and the CPI determines a school's AYP.

Further, the web-based report 300 may also provide other useful data 340 for review by a teacher or other user. Other data 340, for example, may describe how a student is performing on Scaffolding questions when he answers incorrectly or requests a hint. A teacher can use the other data 340 to initiate a discussion with the student about the appropriate ways to use the hints provided by the system/computer-based tutor. These hint attempts, and other metrics, can be used to build an effort score (Walanoski & Heffernan, 20011a, 20011b). While the web-based report 300 provides good summative information, additional reports, such as the web-based report 350 of FIG. 3B can assist a teacher in adjusting their lesson plan based on the results.

FIG. 3B shows an example embodiment displaying a web-based report 350 allowing a teacher to identify the skills for each student. In particular, FIG. 3B shows a sample set of the skills, such as the top five knowledge components 360 and the bottom five knowledge components 365, the ASSISTment system tracks. One benefit of providing the top and bottom five knowledge components (360, 365) via the web-based report 350 is that teachers can quickly identify particular strengths and weaknesses for each student. Teachers, for example, can click on or otherwise select a skill name 370 and display each item for the subject skill name 370 for a better understanding of strengths and weaknesses. In a convenient embodiment, teachers can view data inside of a particular framework (e.g., the Massachusetts Curriculum Frameworks), where the first two columns display which Massachusetts Learning standards are associated with a subject skill. It should be understood that embodiments of the present invention may applied to any standardized system or for use in a non-standardized environment and the above is merely an example.

In an embodiment, the ASSISTment system provides longitudinal tracking of a state test data (Anozie & Junker, 2006; Ayers & Junker, 2006; Feng, Heffernan & Koedinger, 20011b). Studies have shown that providing a student with two simulations (e.g., MCAS tests) in a row, one simulation can predict the other with about an 11% error rate. In an embodiment, the ASSISTment system considers the student's answers and assistance used to achieve an error rate of about 10.2%. The results indicate that the ASSISTment system can give students both a benchmark assessment of their skills as well as a longitudinal assessment with good proprieties. As a result, the ASSISTment system facilitates the benefit to a student understanding the relationship of their knowledge and a potential passing scored in a standardized test. For additional benefit, the ASSISTment system may also do one or more of the following: 1) integrate the curriculum as implemented by one or more teachers; 2) inform students, parents, or teachers detailed information about what skills a given student has mastered; or 3) implement mastery learning for one or more subjects.

Using the ASSISTment system, teachers are more effective because of the computer-based tutoring and reporting capabilities. One benefit of the ASSISTment system is increasing the usefulness of data for teachers by permitting them to more closely monitor the curriculum they are actually instructing in class. Further, making the reports, such as the web-based reports 300, 350 for teachers is an effective way to provide teachers with real-time information for one or more students. The web-based reports 300, 350 may be presented via email, displayed on a monitor screen, or printed allowing a teacher to have multiple options for reviewing reports. One such way to effectively generate and deliver the reports is by storing information in databases and stream processing the data from the databases.

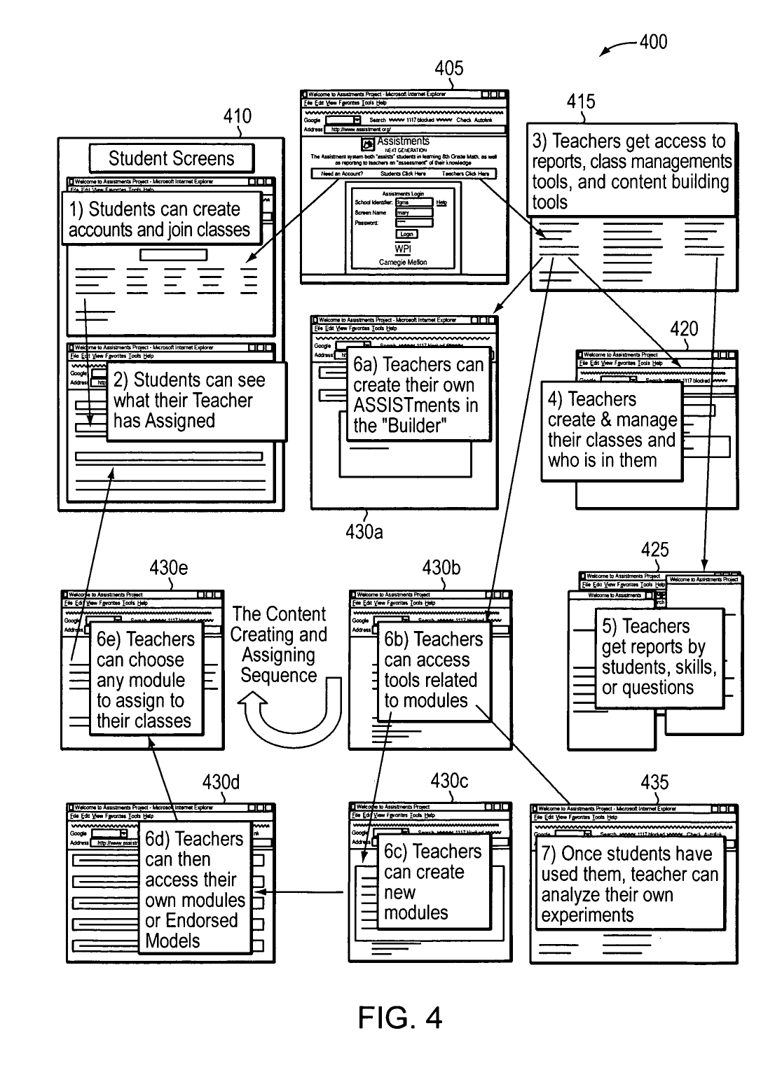

FIG. 4 shows multiple screen shots a user can customize in accordance with embodiments of the present invention. In particular, FIG. 4 summarizes the high-level management available to teachers, including authoring ASSISTment system questions, such as the question shown in FIG. 2. After starting the ASSISTment system 400, the user or teacher creates or logs into an account from the main screen 405 (similar to 100 of FIG. 1). It should be understood that students have the ability to create/log into their account in the main screen 405 or view an assignment list 410, where the student can start or resume work with the tutoring system.

When a teacher logs in, the ASSISTment system 400 displays a tools screen 415 for building ASSISTments, ordering student assignments, tracking student progress, running experiments, evaluating overall results, or other useful tools. Teacher accounts can access, among others, three main features from the tools screen 415: a management screen 420 for managing classes, students, and/or assignments; a reporting screen 425 for reporting on students learning; and assignment screens 430a,b,c for creating and assigning content. Further, a teacher can access a tool that uses the assignment screen 430c, and teachers can create many different kinds of sequences of problem (from linear order to randomized controlled experiments). For those teachers that want to modify content (or make their own) there is an ASSISTment Builder tool 430a accessed over the Internet or other suitable interface.

The ASSISTment system 400 also provides other features that include the ability to browse available modules 430d and assign modules to a class 430e. Assigning modules to a class 430e can be used to supplement the materials that each student in a school district is assigned by default. As a result, the assignments appear on the student's assignment list 410 when they log into the ASSISTment system 400. Further, a teacher can use an analyze screen 435 to analyze how effective their modules were at encouraging students to learn.

Using tools that build, run, and analyze experiments lead to more effective learning then just providing hints (Razzaq & Heffernan, 2006). Such a tool uses detailed reporting closely tied to the material students are working on and makes it easer for teachers to use data-driven decision makers to alter their planned instruction in response to the need of the majority of the class. For gaps in students' knowledge that are shared by a small proportion of the class, the ASSISTment system 400 performs the bookkeeping necessary for a mastery learning system that will provide automatic, individual instruction. Further, the ASSISTment system 400 provides this information to students, teachers, and/or parents via email, automated phone calling, or printed reports.

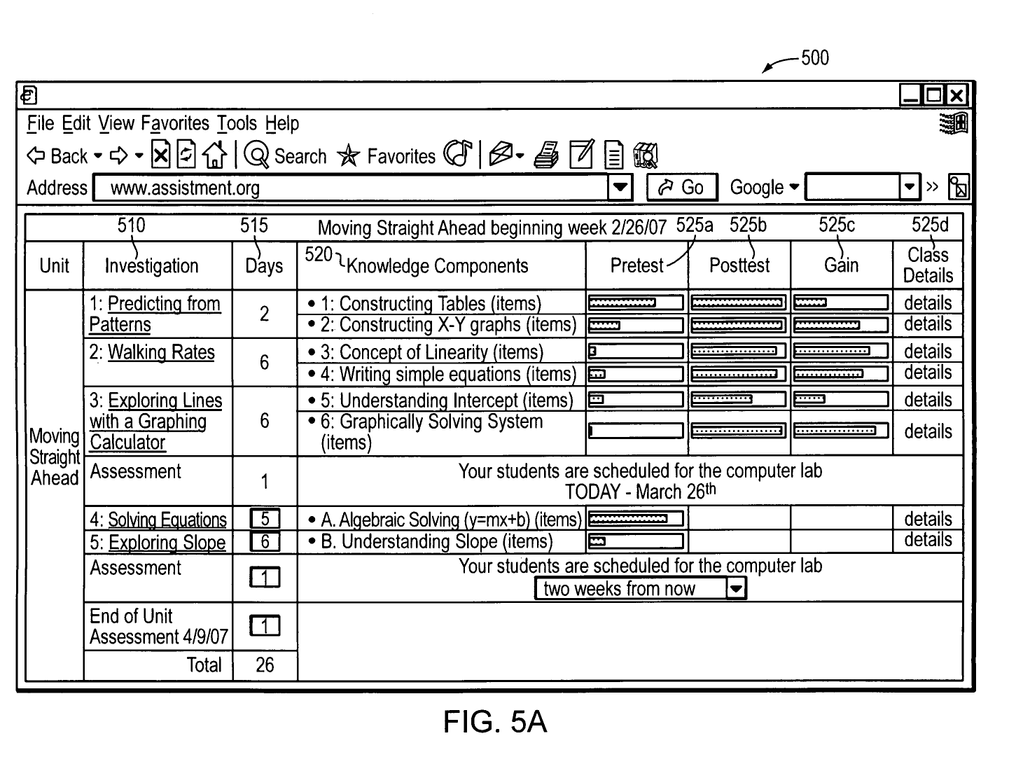

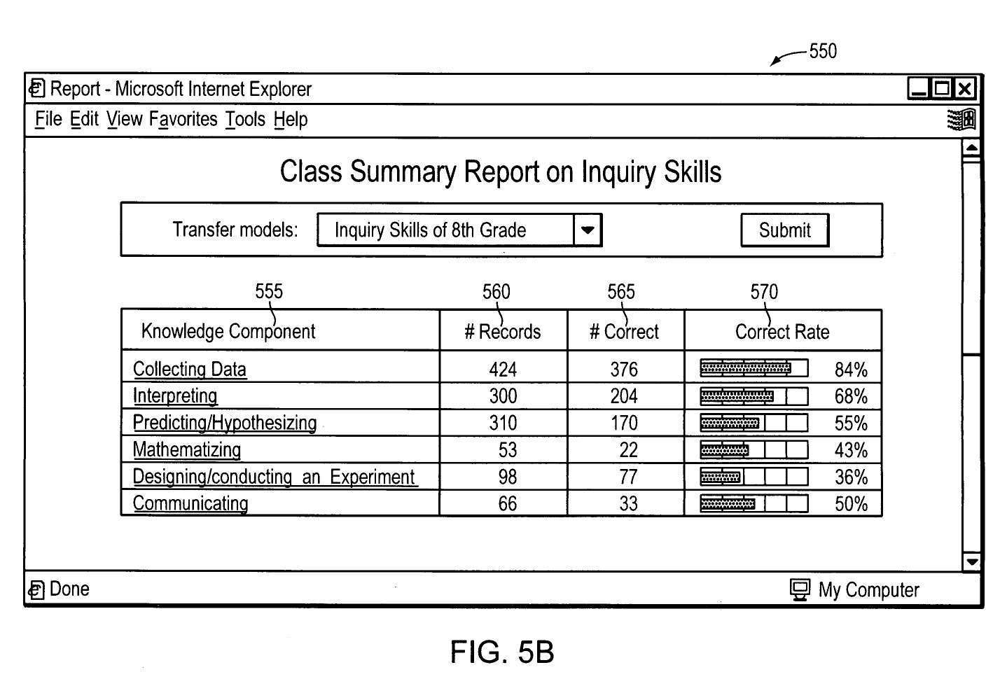

FIG. 5A shows a report display 500 for a teacher providing student skills for a topic. In particular, FIG. 5A shows an investigation 510 for a class or student that lists topics and the number of days 515 a teacher should spend on each topic. Additional columns 525a,b,c,d show knowledge components (i.e. skills) 520 that can be added in order to turn the scope and sequence of the lessons into a useful way of structuring reporting to teachers. For example, the ASSISTment system 400 maps the skills of the fine-grained cognitive model to the investigation 510 topics to facilitate better lessons for students.

In an embodiment, the ASSISTment system 400 provides a targeted assessment for each subject a student is currently working on in the classroom. The ASSISTment system 400 also performs some sampling of content/subject areas that each student has not yet covered, as well as reviewing content. If teachers have fallen behind the classroom schedule, teachers can update their own individual scope to keep the ASSISTment system 400 synchronized with their classroom instruction.

The ASSISTment system 400 provides reports for a teacher to review. For example, the pretest number 525a reports a longitudinal assessment estimate on the probability that the student knew that skill at the beginning of the unit. This estimate is derived from the student's performance on the pretest number 525a. Following the instruction of each skill for a pre-tested subject, the ASSISTment system 400 provides a posttest number 525b, followed by a gain score 525c calculated by subtracting the pretest number 525a from the posttest number 525b. Using these numbers, the ASSISTment system 400 identifies the learning progress for each student.

In an embodiment, the ASSISTment system 400 provides data to a teacher regarding a particular subject. Based on this data, the teacher may decide additional time is needed to review the concept. The teacher may also notice that her students already have a high posttest number 525b for the next unit (e.g. equation solving). Given this information, the teacher may decide to spend two more days on a previous subject and two days less on the next unit with high posttest numbers. In another scenario, the teacher may notice that 10% of her class has not yet mastered the Concept of Linearity, but that percentage of students is too small to make a class-wide adjustment. A teacher may use a class summary report 550, as shown in FIG. 5B, to facilitate a better understanding of the class by reviewing the knowledge component (skills) 555, number of records 560, number of correct 565, and correct rate 570.

Moreover, the ASSISTment system 400 encourages the student to master a topic if it remains un-mastered after 2 weeks, thus providing individualized tutoring to students. The teacher may then check to see who has not yet mastered the skill, and can select a detailed report from the class details 525d for any student. In this way, the ASSISTment data in the web-based report 500 allows teachers to quickly note patterns in class performance, and make data-driven adjustments to classroom instruction.

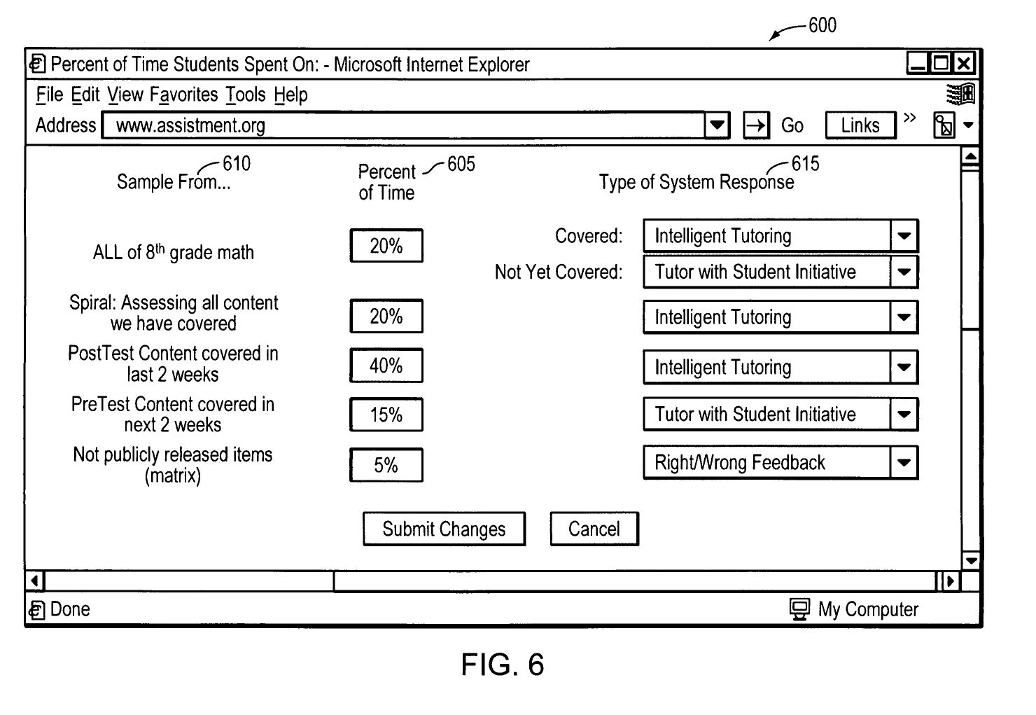

FIG. 6 shows an interface 600 for setting different time allocation percentages for a given assessment problem. In particular, a percentage of time 605 can be set by a user, such as the district representative or a teacher. In the example interface 600, the percentage of time 605 is set to 20% for a topic 610 (e.g., ALL of 8^{th} grade math). A teacher may also indicate whether the topic 610 has been covered in class via the status column 615. For example, a teacher can select “Tutor with student initiative”, which allows students to skip the problems if it is too complicated. On the other hand, if the topic 610 has been covered in class, the ASSISTment system 400 does not allow the student to skip the topic 610. That is, for topics or content that has been covered, a student runs through the intelligent tutoring so they cannot skip over their weaknesses. Moreover, using the interface 600 a user can identify how the student results vary over all testing skills. This is particularly useful for aiding students in passing standardizing testing.

### Parent Reports for ASSISTment System

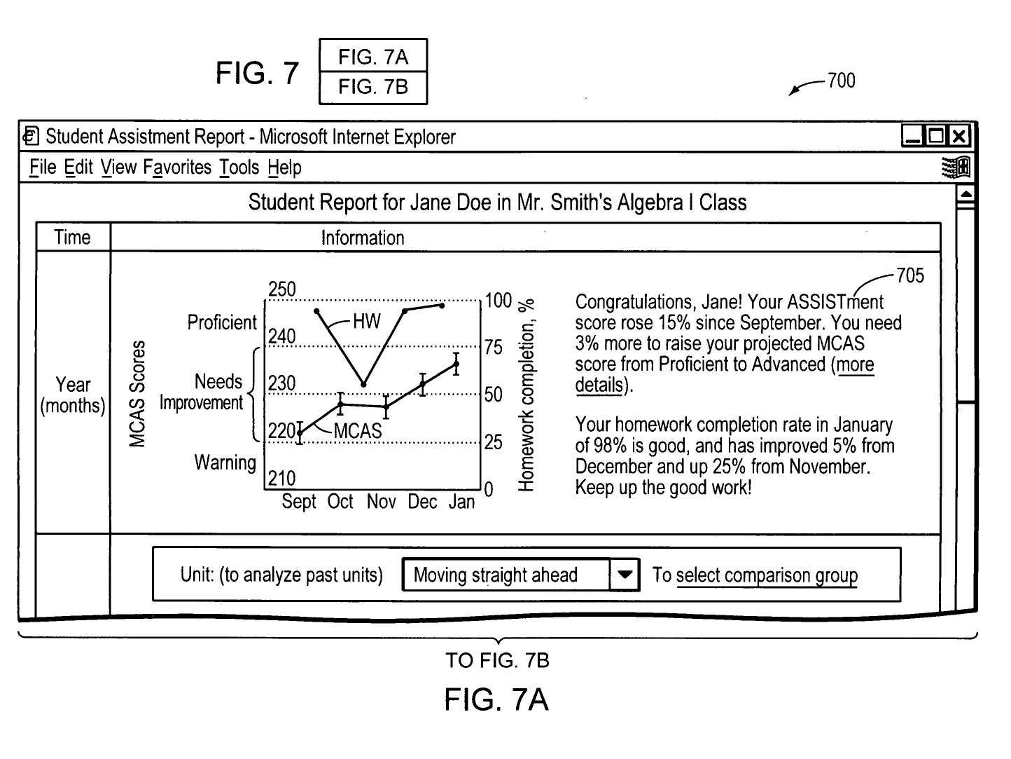

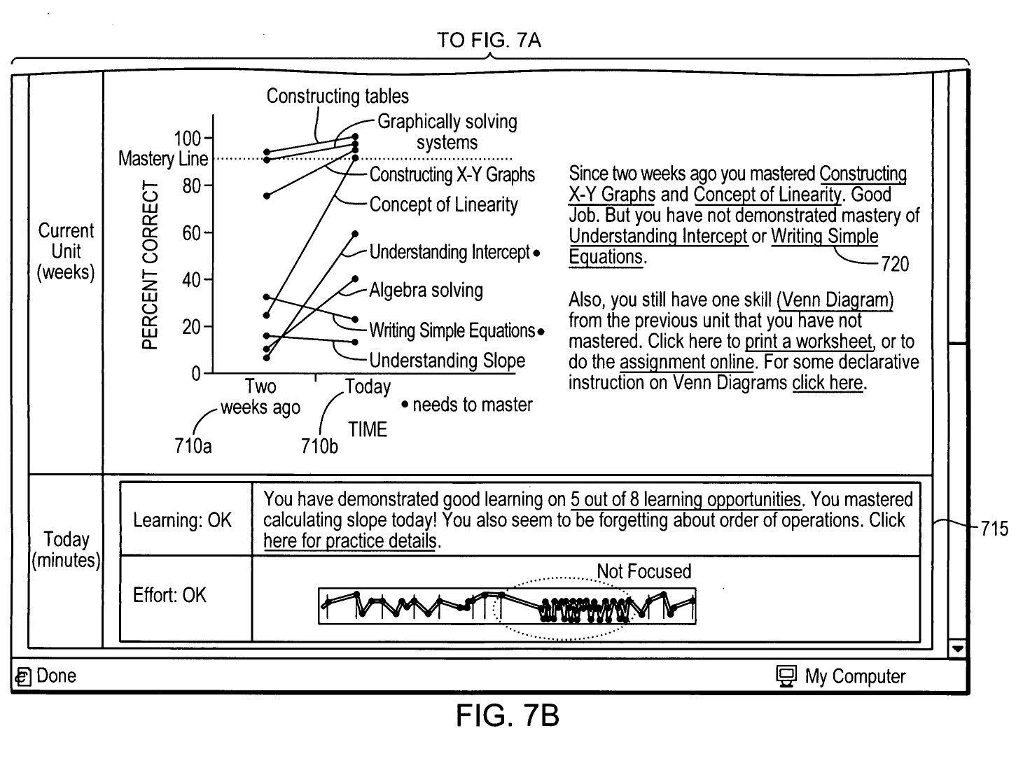

FIGS. 7A-B shows a report 700 providing detailed information of a student's performance for review by parents, teachers, and/or students. The report 700 displays a student's (i.e., Jane Doe) progress information 705 for a period of time (e.g., a year) that may be measured longitudinally based on a standardized test (i.e., MCAS) or a longitudinal assessment/analysis, which is a measurement of an accumulation of skills. By reviewing the progress information 705, the ASSISTment system 400 determines that the student, for example, did not improve much in November. Subsequently, however, the student has shown a good rate of improvement, and is close to moving from the NCLB MCAS ranking of Needs Improvement to Proficient. Moreover, the student's homework completion rate for the year has increased. The ASSISTment system 400, using the progress information 705, suggests that there is a correlation with a low homework rate and a small amount of learning gain for the student. Using the progress information 705, the ASSISTment system 400 stores predictive information for a student, which includes time spent per question, number of attempts, tutoring used, percentage correct, and other useful information about the student's interaction. Although this suggestion is useful, the ASSISTment system 400 provides even more useful information by displaying the progress information 705 together with the unit information 710a,b as illustrated in FIG. 7B.

In an embodiment, the unit information 710a-b shows progress on the student's individual skills that are associated with the current unit or lesson at two different time samplings (e.g., two weeks ago and today). In the current example, Jane used the computer lab today, and her class is half-way through the “Moving Straight Ahead” book (FIG. 7A) indicating that the class has “covered” the first 6 skills of the subject. Since the unit started two weeks ago, the student's data in the middle of the unit information 710a (FIG. 7B) represents a pretest on the knowledge. Data, such as the unit information 710b (e.g., today's data) is helpful to learn of a current update for the student.

The ASSISTment system in report 700 indicates that for Jane four skills are above the mastery level of performance, while 4 more skills are to be mastered before the end of the unit. The two skills tagged with large circles (Writing Simple Equations, and Understanding Intercept) are the two she has been introduced to but not yet mastered. It is useful to note that the student is dissimilar to her classmates in that Understanding Intercept was highlighted, indicating to the teacher that it is a weak skill requiring more instructional time. But the student is similar to her peers when it comes to Writing Simple Equations: here is where mastery learning features will help the student, as the computer will ask the student to practice until they reach a proficiency level. Reaching proficiency may also be performed in a small tutoring group, where the student may bring the report 700 to her tutoring session to better focus the tutor.

The ASSISTment system's report 700 may also include a progress report 715 (FIG. 7B) that displays the student progress for a given time period (e.g., a day). An example progress report 715 (FIG. 7B) may indicate that the student has learned on 5 out of 8 opportunities presented, thus demonstrating a good amount of learning. In an embodiment, the progress report 715 can be color-coded to identify a student's effort or focus, or to designate a correct or incorrect response. In use, the progress report 715 allows a teacher to quickly identify when a student is struggling and may choose to return to the problem subject area for the student. The ASSISTment system 400 also identifies when a student is not on-task for a problem when a student takes an extended period of time for a problem (e.g., the ASSISTment system 400 indicates that the student is “Apparently not focused”). This problem is described in detail in Walonoski & Heffernan, Detection and Analysis of Off-Task Gaming Behavior in Intelligent Tutoring Systems, Springer-Verlag: Berlin. pp. 382-391 (2006). The entire teaching are hereby incorporated by reference. The ASSISTment system 400 makes the identification because the problem was on a subject the student has already shown proficiency on, making the ASSISTment system 400 more likely to think that the student is not well focused. It is useful to note that after completing an item, a student can be presented with a second opportunity to demonstrate if learning occurred.

In an embodiment, the ASSISTment system 400 forwards the report 700 to a parent in varying levels of detail as requested. For example, at the beginning of the year, a teacher may inform parents of goals and ask them for a notification preference for reports including email, a computerized voice phone call via the CONNECT-ED system, or paper. Due to the Digital Divide (DeBell & Chapman, 2004) in the country, the ability to deliver a text-to-speech message to parents is helpful to ensure equal access. Parents will be able to have these reports printed out on a weekly basis, but to conserve printing costs, parents with email can choose to have the reports emailed to them.

Sending the report 700 to a parent is useful to a student's increased learning in many ways. For example, Lahart, Kelly, and Tangney (2006) found that parents who wanted to tutor their children benefited from support from an intelligent tutoring system that gave them some ideas about how to guide their children. In an example embodiment, a parent reviews the report 700 of their child's progress. The parent notices that the child's homework completion rate has increased from a few months ago and recognizes that the child has recently mastered Constructing X-Y graphs and the Concept of Linearity. In an embodiment, the email may provide the parent with clickable links (e.g. hyper-links or embedded html) to view example problems.

In an embodiment, a parent reviewing the report may identify that the student has not mastered Understanding Intercept and Writing Simple Equations and the class is moving on with a unit test in two weeks. The parent may click the presented link 720 (FIG. 7B) relating to the skills and obtain a lecture on the skills as well as one or more examples. The parent may find a video of a teacher or an example that is useful. Given the report 700 information, the parent decides to review these examples with their child to increase learning.

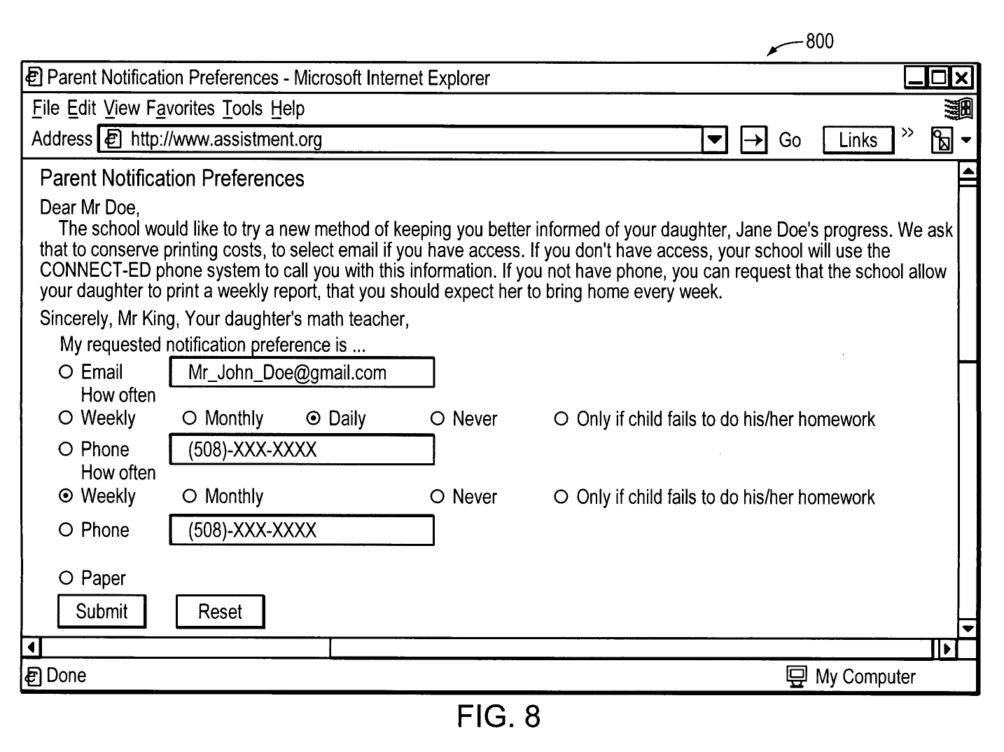

FIG. 8 shows a preference screen 800 a parent may use for configuring how to receive the report 700. By using the preference screen 800 of the ASSISTment system 400, a parent can change their preferences online. It is useful to note that a parent is not limited to using the preference screen 800, but may also contact the teacher in any manner (e.g., by phone). It should be understood that one benefit of using the email version is the email version contains embedded links that enables parents to learn additional information about their child's reports.

In an example embodiment, the ASSISTment system 400 tracks skills for each student and includes a corresponding status (e.g., having difficulty or proficient) and continues to do so until a student masters all skills. At any time the student is ready, the ASSISTment system 400 allows the student to request a test on the mastery of a given subject/skill. A student may learn by using a video of a teacher providing declarative instructions, a web page that provides a worked example, or other manner useful to the student. To support mastery learning, the ASSISTment system 400 tracks which skills have been mastered, and which have not. The ASSISTment system 400 informs the student, parent and teacher about the missing skills, and allows the student to use video explanations, worked examples, or resources external to the ASSISTment system to solidify their knowledge. The student can ask to be given a few randomly selected items to see if they have reached mastery. The student can do this by requesting the ASSISTment system 400 to print out a worksheet. It is useful to note that while taking the test online, the student may obtain tutoring as they work on the items they answer incorrectly on their first attempt without any hints.

### Measures

Although, different research questions have different measures of learning, at least one measure should be common throughout to obtain a good assessment. In an embodiment, tracking students' MCAS (a standardized test) scores is useful. The ASSISTment system 400 shares the results from tests to predict gains for a student with regard to a standardize test as an unbiased indicator of growth.

In addition to measures of gain, the ASSISTment system 400 also measures student attitudes. By asking questions about motivation, sense of math competence (“I am good at math.”), attitudes about how you succeed at math (“I think some people are just good at math”), the ASSISTment system 400 can identify student attitudes by using these randomly selected survey questions answered by the student.

In an embodiment, teachers can monitor the steps some students are going through to reach mastery as student initiative will be a useful explanatory variable in determining the utility of a mastery learning system. If a student does not get to spend any extra time to use the mastery learning component, the component has a limited effect. If some students get too far behind, different strategies may be employed by the teacher to help those students. In this way, better understanding for student learning may be achieved. It is useful to note that the student progress continues to be collected every year and as such provides a better understanding of student learning. As a result, the ASSISTment system 400 adapts over time for a student and can change 1) a student perception of the utility and helpfulness of the system; 2) their own self perceptions of their ability to do math or a subject; 3) their beliefs about what are the ways students get good at math/a subject; or 4) other learning hindrance.

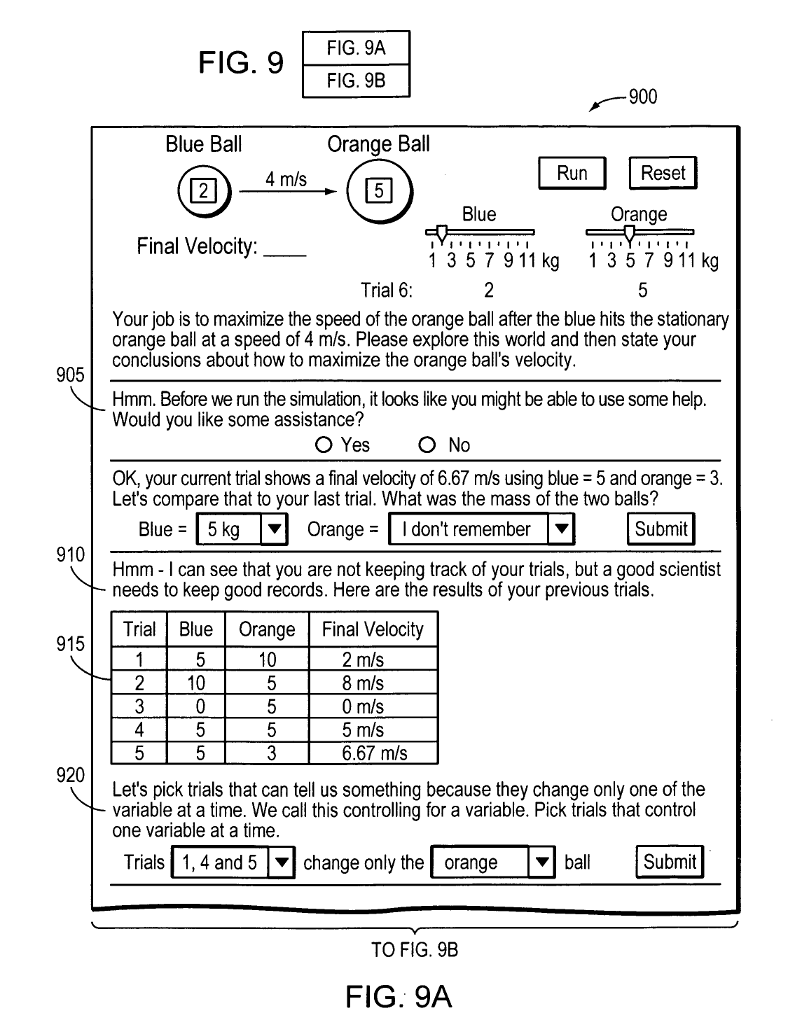

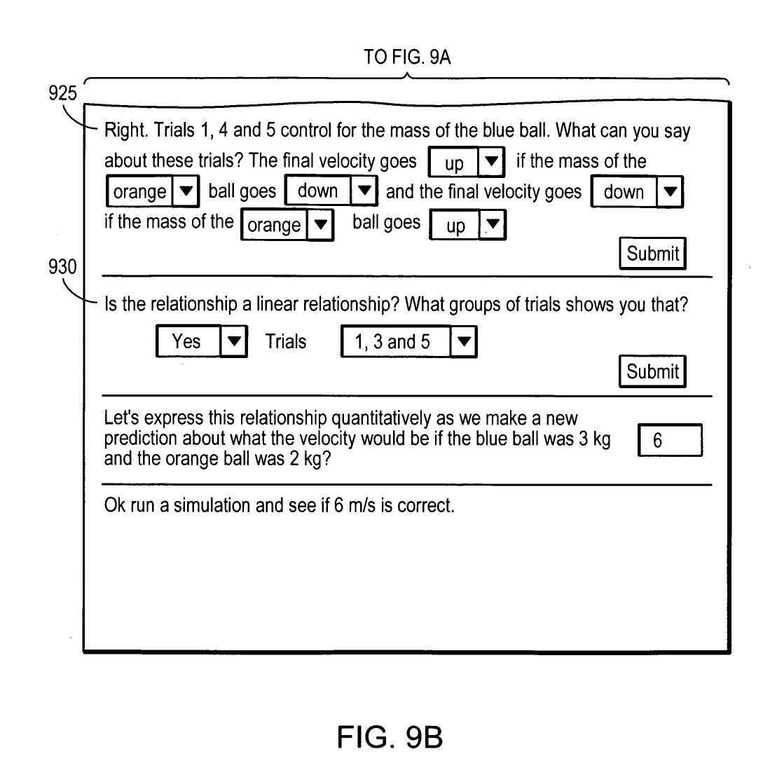

In an embodiment, the ASSISTment system 400 creates a science experiment environment to better the learning quality for a student. In particular the ASSISTment system 400 provides tutoring designed to promote sophisticated skills for “conducting experiments.” By asking students to identify experiment controls for a single variable as well as explain what those observations mean allow a student to learn. An example of a tutoring display in the ASSISTment system 400 is shown in FIG. 9 consisting of FIGS. 9A and 9B.

FIG. 9 shows a tutoring display 900 presented to a student. A top portion of display 900 provides the subject science experiment, while the lower portion shows tutoring of inquiry learning. In this example embodiment, the student has completed five trial experiments and demonstrated poor inquiry behavior by manipulating more than one variable at a time (the masses of the balls). The ASSISTment system 400 detects for each student inputs, assesses, and responds. As a result, the ASSISTment system 400 recognizes this student requires assistance and provides an assistance request 905 to the student.

At first, the ASSISTment system 400 offers an assistance request 905, but if the student continues to need assistance, the system seeks to engage the student in a tutoring lesson. In use, the ASSISTment system 400 checks whether the student is recording the data they should be collecting and provides the student with an instruction 910 indicating the same. Next, the system 400 verifies that the student settings are from a previous trial. In this example, the student does not know the settings, indicating that the student has not been recording data. Consequently, the system 400 responds by showing the data 915 the student should have, but the ASSISTment system 400 notes the student's weakness here. If the student enters a correct answer, the ASSISTment system 400 updates its indicator about the probability that the student now knows this skill called “Collecting Data.” Further, a sample indicator can be “Knowledge Tracing” as described by Corbett and Anderson (1994) and is a feature that is executed by the ASSISTment system 400 (Pardos, Heffernan, Anderson & Heffernan, 2006). The teachings are hereby incorporated by reference.

It is useful to note that the table in the student's first two trials shows more than one variable at a time was changed, but the ASSISTment system 400 allows some haphazard exploration to prevent the computer-based tutor from being overbearing to the student. Each problem has a different jump-in time setting, which initiates the tutor. Some problems that typically use many trials have a longer jump-in time, while other problems that use fewer trials will have a shorter jump-in time. After the tutor jumps-in, the ASSISTment system 400 asks the student to pick which trials had only a single variable changed in the question 920. The student, using pull-down menus of the question 920, communicated correctly that trials 1, 4, and 5 controlled for the mass of the blue ball. The system 400 then indicates a correct response 925 (FIG. 9B) to the student and credits the student for the grade level Inquiry Skill called “Conducting experiments.”

Next, the ASSISTment system 400 asks a follow up question 930 for the student to “Mathematize” by stating the correct quantitative relationship between the velocities and masses of the two balls. A student gets more credit for the “mathematize” inquiry skill if the student uses fewer hints and takes fewer attempts to solve the problem. In some embodiments, the student can be given another chance to try to answer the question, which is to minimize the mass of the orange mass ball and to maximize the mass of the blue ball. After a student is completed with the tutoring display 900, the student is asked to input their answer (not shown).

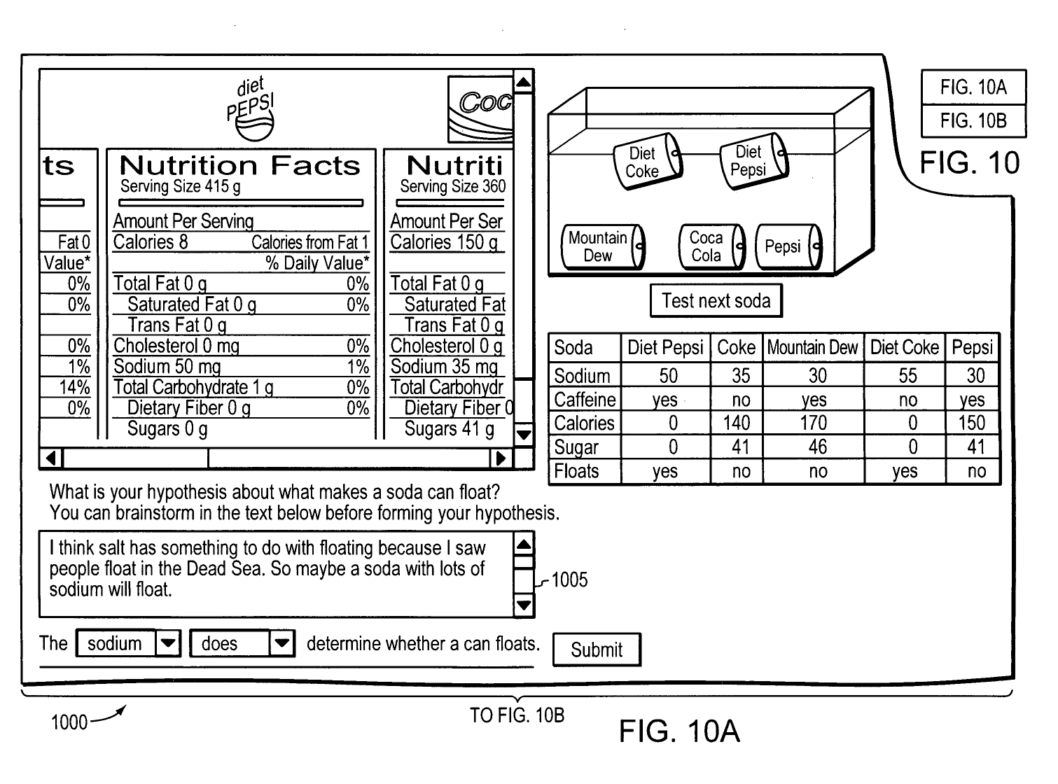

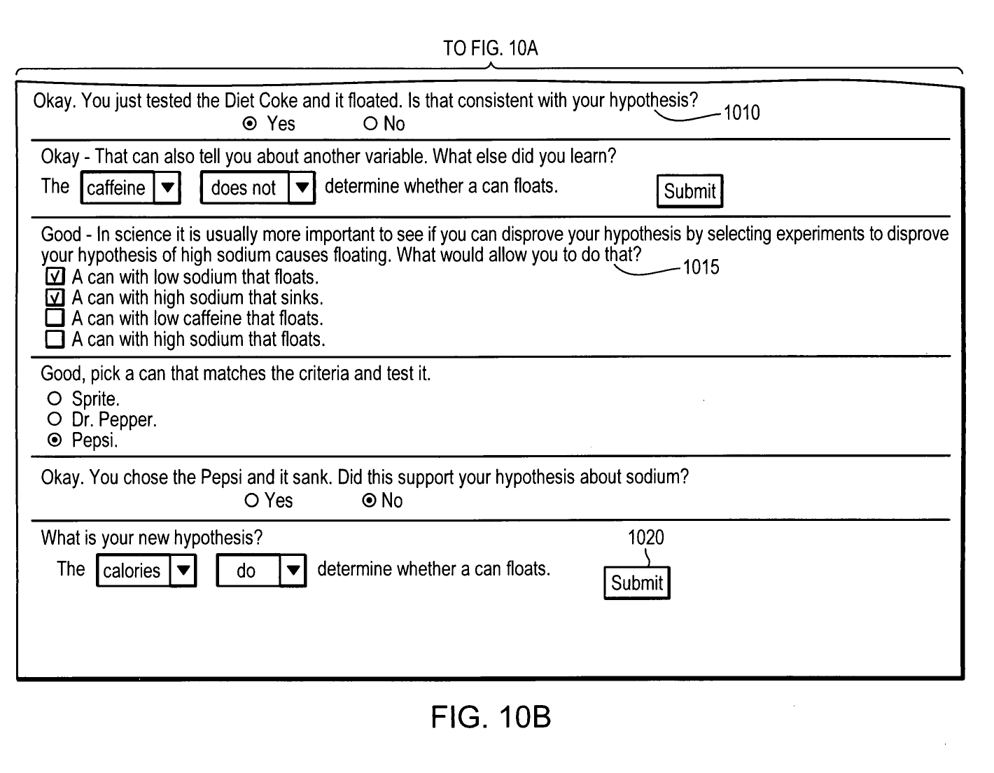

FIG. 10 (formed of FIGS. 10A and 10B) provides an example science problem 1000 presented for student completion in accordance with embodiments of the present invention. For example, the student has been working through a problem, recording data, and conducting “experiments” (Collecting data—Inquiry Skills). The student makes a hypothesis 1005, for example, that the amount of sodium predicts whether the can will float (Predicting/Hypothesizing Inquiry Skills). The student selects a Diet Coke 1010 (FIG. 10B), which supports the student's hypothesis 1005 (FIG. 10A). The ASSISTment system 400 coaches 1015 (FIG. 10B) the student on how to disprove the hypothesis by making an intelligent choice on which soda to test next (scaffolding Designing/Conducting experiments Inquiry Skill). After the student disproves the sodium hypothesis, the student makes a new hypothesis 1020 as shown in FIG. 10B. In this example, there are two hypotheses: sugar or calories (Predicting/Hypothesizing Inquiry Skill). The ASSISTment system 400 asks the student to state a conclusion in a short answer format (Communication Inquiry Skill). The ASSISTment system 400 does not need to auto-score this data, but the short answer responses that the student generates here serve a variety of pedagogical purposes, i.e., as orienting tasks or to rectify learning (Gobert, 2005). These types of tasks also serve the important “Communication” goal from the science standards.

In an embodiment, the ASSISTment system 400 promotes students' inquiry skills via a technology-based assessment system for Physical Science to be aligned with the curricular frameworks. The ASSISTment system 400 performs this by: 1) leveraging the structure and software from the ASSISTments project; 2) extending the logging functionality for the ASSISTments system 400 in order to capture students' fine grained actions with models; 3) evaluating students' interactions with models using a framework for aggregating students' actions into domain-general inquiry skills (Gobert et al., 2007); and/or 4) extending the existing reporting infrastructure to report students' inquiry skills to teachers for formative assessment so the teacher can determine which skills his/her students are performing poorly on. In this way, the ASSISTment system 400 provides experimenting, longitudinal assessing, and inquiry questions.

In one example, a student explores the characteristics of the period of a pendulum via the ASSISTment system 400. This example allows students to add weight to the pendulum, change the length of the pendulum, and decide how far back to pull the pendulum. The students develop hypotheses on which factor(s) affects the swing period of the pendulum; they design experiments and run them, and once they have completed their trials, they draw conclusions about which factor affects the period of the pendulum.

After running several trials, the student exhibits a common error: changing more than one variable at a time. It has been documented by Chen and Klahr, 1999 (and others) that many students do not know the “control for variables” strategy. In AMI, for students who repeatedly fail to use this strategy, the system 400 provides assistance so they can fully appreciate the difference between confounded and un-confounded experiments. As a result, the ASSISTment system 400 decides to jump-in (inserts tutoring portion) to keep the student from wasting time on unproductive exploration and coaches (tutors or otherwise guides) the student on how to make an intelligent choice about which values to assign to the variables. In this way, continued learning is achieved.

### System Architecture

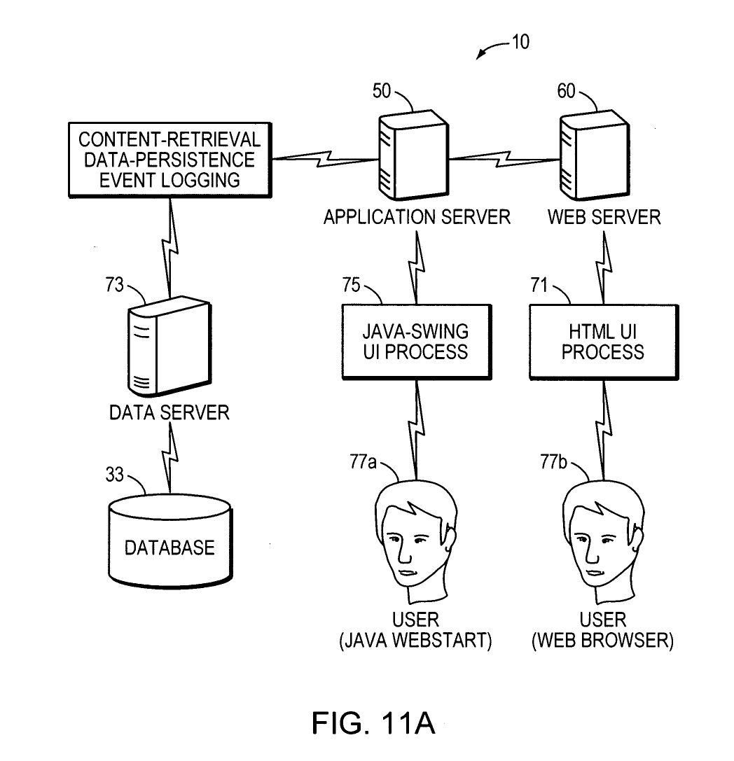

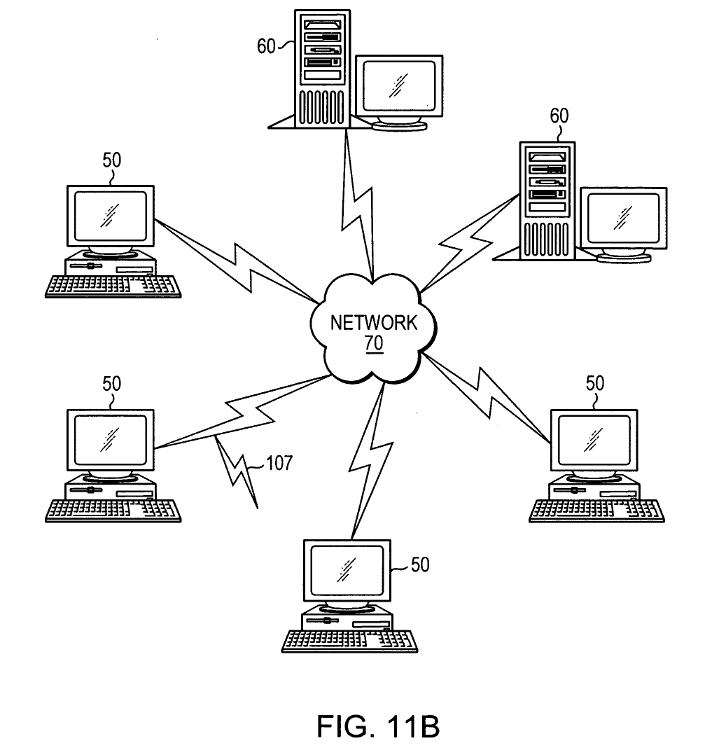

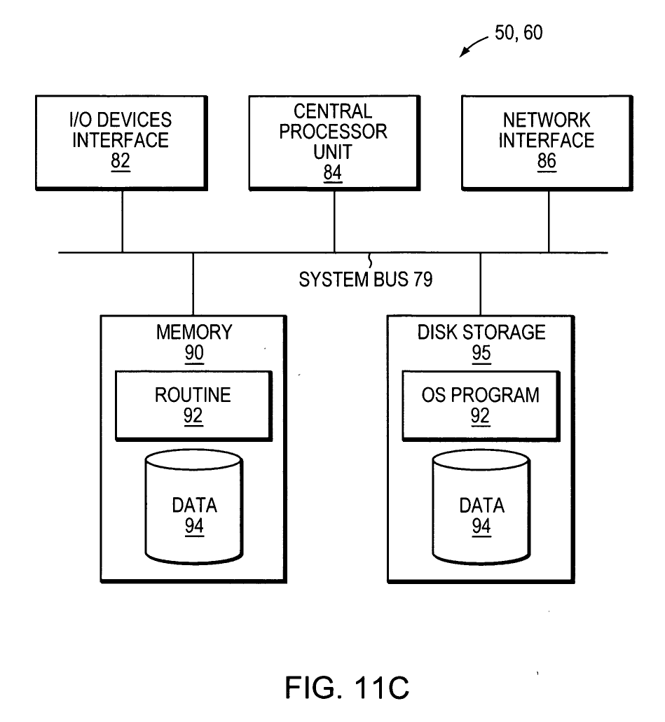

In a preferred embodiment, the network architecture is configured as shown in FIG. 11A. The application server 50, web server 60 and data server 73 can run on one machine or separate machines. Additional web servers 60 can be added for load balancing. The data server 73 handles database requests and data persistence (i.e., file system or database 33 data storage and retrieval). The data server 73 is also responsive to user level and framework level events and logs the same in database 33. The database system 33 is any database with a JDBC driver.

Users on different platforms may use the same invention system 10 simultaneously. Illustrated is one user 77a obtaining access through a Java Webstart network software launch of the invention program (e.g. ASSISTment system 400 described above), and another user 77b obtaining access through a web browser supported by web server 60. The HTML user interface process 71 converts an abstract user interface into HTML widgets. The Java Swing user interface process 75 converts the same abstract user interface into Java Swing widgets. The user interactions represented as respective user interface widgets cause various content retrieval and storage events at application server 50, web server 60 and data server 73. Illustrated users 77 include teachers, parents, and students. Other configurations are suitable. Generally, such a computer network environment for deploying embodiments of the present invention is further illustrated in FIGS. 11B and 11C.

Referring to FIGS. 11B and 11C, client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 11C is a diagram of the internal structure of a computer (e.g., client processor/device 50 or server computers 60) in the computer system of FIG. 11b. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 11b). Memory 90 provides volatile storage for computer software instructions 92 and data 94 used to implement an embodiment (e.g. system 400) of the present invention. Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In an alternate embodiment, the invention system maybe implemented in WTRUs (wireless transmit/receive units), such as cell phones, and PDAs.

While this invention has been particularly shown and described with references to example embodiments thereof, it will be understood by those skilled in the art that various changes in form and details may be made therein without departing from the scope of the invention encompassed by the appended claims.

1. A method for increasing the quality of learning for a student comprising computer implemented steps of:
enabling a student to answer one or more questions of a problem set;
for the student, storing in a computer store information for each answer of the one or more questions over a period of time;
using a digital processor, analyzing the stored information for each student answer in a longitudinal manner, including tracking individual skills; and
identifying one or more deficiencies in learning of the student based on the longitudinal analysis.

2. A method as is claimed in claim 1 wherein the problem set is directed to one subject area.

3. A method as is claimed in claim 1 wherein the information indicates a student result for each question and any predictive information about the student interaction.

4. A method as is claimed in claim 1 wherein the predictive information includes time per question, number of attempts, tutoring used, percentage correct, and other useful information about the student's interaction.

5. A method as is claimed in claim 1 wherein the step of identifying one or more deficiencies further comprises the step of identifying the student's attitude.

6. A method as is claimed in claim 1 wherein analyzing the information for each student answer in a longitudinal manner is summative of a student's learning over the period of time, wherein summative includes an accumulation of skills.

7. A method as is claimed in claim 1 further comprising the step of generating a report for the student based on the longitudinal analysis.

8. A method as is claimed in claim 7 further comprising the steps of:
viewing the report for the student; and
a user, based on the report, adapting a learning program for the student.

9. A method as is claimed in claim 8 wherein the user is a parent or teacher.

10. A method as is claimed in claim 1 further comprising the step of adapting classroom teaching program based on the longitudinal analysis of one or more students.

11. A computer system for increasing the quality of learning for a student comprising:
an interface configured to enable a student to answer one or more questions of a problem set; and
a processor module responsive to the interface and storing in a computer store information for each student answer of the one or more questions over a period of time, and the processor module analyzes the stored information for each student answer in a longitudinal manner, tracks individual skills, where the processor module identifies one or more deficiencies in learning of the student based on the longitudinal analysis.

12. A computer system as is claimed in claim 11 wherein the problem set is directed to one subject area.

13. A computer system as is claimed in claim 11 wherein the memory stores a student result for each question and any predictive information about the student interaction.

14. A computer system as is claimed in claim 11 wherein the predictive information includes time per question, number of attempts, tutoring used, percentage correct, and other useful information about the student's interaction.

15. A computer system as is claimed in claim 11 wherein the process identifies the student's attitude using the interface.

16. A computer system as is claimed in claim 11 wherein the process creates a summative of a student's learning over the period of time, wherein summative includes an accumulation of skills.

17. A computer system as is claimed in claim 11 wherein the process creates a report for the student based on the longitudinal analysis.

18. A computer system as is claimed in claim 17 further comprising:
the interface configured to present a report relating to the student; and
a second process, based on the report, adapts a learning program for the student.

19. A computer system as is claimed in claim 18 wherein a parent or teacher reviews the learning program in such a manner as to allow the student to learn more effectively.

20. A computer system as is claimed in claim 11 wherein a teacher reviews the report or learning program in such a manner as to allow the teacher to teach more effectively based on the longitudinal analysis of one or more students.

21. A computer system for increasing the quality of learning for a student comprising:
means for enabling a student to answer one or more questions of a problem set;
means for storing in a computer store information for each answer, for the student, of the one or more questions over a period of time;
means for analyzing, using a digital processor, the stored information for each student answer in a longitudinal manner;
means for tracking individual skills for each student; and
means for identifying one or more deficiencies in learning of the student based on the longitudinal analysis.
